(19) United States
(12) Patent Application Publication
(10) Pub. No.: US 2026/0370280 A1
(43) Pub. Date: Nov. 19, 2026

(54) SYSTEMS AND METHODS FOR RADIO COVERAGE USING INTELLIGENT BEAMFORMING

(71) Applicant: VERIZON PATENT AND LICENSING INC., Basking Ridge, NJ (US)

(72) Inventors: Viviana Rivera TORRICO, Mission Viejo, CA (US); Vishwanath RAMAMURTHI, San Ramon, CA (US); Keith Robert MARTIN, Belle Mead, NJ (US); Wai Shun Wilson WONG, San Jose, CA (US)

(73) Assignee: VERIZON PATENT AND LICENSING INC., Basking Ridge, NJ (US)

(21) Appl. No.: 19/207,657

(22) Filed: May 14, 2025

(51) Int. Cl. H04B 7/06; H04L 41/5006

(52) U.S. Cl. CPC H04B 7/0617; H04L 41/5006

(57) ABSTRACT

Disclosed are systems and methods that provide a framework for dynamically adjusting transmission power and beamforming parameters based on real-time environmental sensing. As discussed herein, the disclosed framework can leverage artificial intelligence and machine learning (AI/ML) algorithms to detect indoor surfaces and obstacles, enabling O-RU to optimize signal propagation for improved coverage and reduced interference in indoor environments. The framework provides a dynamic, intelligent and context-aware approach to indoor wireless communication optimization by leveraging advanced sensing and open network principles to provide functionality for real-time beamforming configurations tailored to complex and evolving indoor environments.

### BACKGROUND INFORMATION

Open Radio Unit (O-RU) is a component of the Open Radio Access Network (O-RAN) architecture that may handle radio frequency (RF) functions in a mobile network. The O-RU may be responsible for RF signal transmission and reception, beamforming and antenna control, and digital-to-analog and analog-to-digital conversion of radio signals.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 provides an example embodiment according to some embodiments of the present disclosure;

FIG. 5 illustrates a non-limiting example embodiment of a network architecture according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

Indoor radio signal propagation is significantly affected by physical barriers, leading to high path loss. Accurate indoor coverage prediction is challenging due to difficulties in calibrating propagation tools and the labor-intensive process of building detailed indoor models, which require identification of barrier locations and materials. These models are further complicated by frequent reconfiguration of indoor spaces and potential misidentification of materials, both of which can significantly affect propagation accuracy. While 5G New Radio (NR) supports beamforming adjustments in both horizontal and vertical planes, current propagation models lack the adaptability to account for real-time changes and are typically limited to the initial design phase, without supporting dynamic beamforming optimization.

To that end, the disclosed systems and methods provide a framework for dynamically adjusting transmission power and beamforming parameters based on real-time environmental sensing. As discussed herein, the disclosed framework can leverage artificial intelligence and machine learning (AI/ML) algorithms to detect indoor surfaces and obstacles, enabling O-RU to optimize signal propagation for improved coverage and reduced interference in indoor environments.

According to some embodiments, the framework can provide an intelligent and adaptive solution for optimizing indoor wireless communication performance through the integration of real-time environmental sensing and dynamic beamforming techniques. Traditional indoor radio frequency (RF) propagation faces significant challenges due to the complex nature of indoor environments, where physical barriers such as walls, furniture, and structural elements create substantial signal attenuation and reflection, leading to poor coverage and unpredictable signal behavior. Additionally, the manual modeling of indoor environments for propagation prediction is labor-intensive and often inaccurate due to dynamic space reconfigurations and imprecise material identification. These limitations have historically confined propagation models and beamforming optimization to the initial design stage of network deployment, with little to no adaptability to real-time environmental changes.

In some embodiments, the framework can address these limitations by leveraging the capabilities of ISAC (Integrated Sensing and Communication) to dynamically sense and adapt to environmental conditions. ISAC technologies enable radio units (RUs) to utilize high-frequency signals not only for communication but also for sensing physical surfaces within the deployment space. Through the transmission and reception of these signals, RUs can detect objects, their shapes, and distances, forming a foundational data set for understanding the surrounding environment. In some embodiments, such sensing process can be continuous and can be conducted using various frequencies, allowing for separation between communication and sensing functions. For example, higher frequency bands may be used for sensing due to their finer resolution capabilities, while lower bands may be used for communication, ensuring optimal operational performance.

According to some embodiments, the framework can function by detecting material types in the environment which enables dynamic adjustment of RF parameters by leveraging the known electromagnetic properties (e.g., permittivity, conductivity, reflectivity) of those materials. Thus, in some embodiments, by identifying whether a surface is metal, wood, glass, or concrete, for example, the framework can predict signal reflection, absorption, and/or scattering characteristics. This information therefore enables the framework to perform real-time optimization of beamforming patterns, improving signal strength, reducing interference, and enhancing coverage. Accordingly, in some embodiments, accurate material detection can enable more efficient and adaptive RF propagation strategies, as discussed herein.

In some embodiments, in conjunction with sensing capabilities, the framework can incorporate AI/ML algorithms, including, for example, computer vision models, clustering techniques, and convolutional neural networks (CNNs), to analyze and interpret the collected environmental data. The interpretation process can generate a detailed spatial map of the deployment area, identifying key obstacles and spatial characteristics relevant to RF signal behavior. In some embodiments, the data processing and modeling may not be performed at the RU level, which may be constrained in processing capacity, but rather centralized within the Radio Access Network (RAN) Intelligent Controller (RIC) as defined by the O-RAN (Open Radio Access Network) architecture.

In some embodiments, the framework can utilize near-real-time and/or non-real-time RICs, which host application modules known as rApps (radio access network applications, non-real-time) and xApps (external applications, near-real-time). These applications can be third-party or proprietary implementations that interface with the management platform of the RAN. Once the RUs collect environmental data, it can be transmitted to the rApps, which may include artificial intelligence (AI)-driven engines capable of performing high-volume data analysis and RF optimization. Such rApps can determine optimal beamforming parameters for each RU, including beam directions, power levels, and beamwidths. Based on the environmental mapping and user location data, the rApps can tailor these parameters to maximize coverage and capacity while minimizing interference and power consumption.

Moreover, in some embodiments, the framework can support beamforming adaptation in both the horizontal and vertical planes, enabling three-dimensional (3D) optimization of RF signals. In some embodiments, beamforming antennas can be configured to produce beam patterns that are dynamically shaped according to the sensed environment. Such beam patterns may vary in intensity and direction depending on the proximity of detected surfaces and the need to avoid interference with other beams or cells. For example, if a particular beam path encounters a nearby barrier, the power allocated to that beam can be reduced, or its direction altered to circumvent the obstruction. Similarly, distinct frequency bands can be utilized across different sectors or cells, with beamforming configurations accounting for frequency reuse and interference avoidance.

In some embodiments, the framework can incorporate a centralized learning model, wherein data from multiple RUs is aggregated and processed to refine the accuracy of environmental sensing and propagation prediction. In this centralized approach, updates to beamforming parameters are coordinated across the network, facilitating a harmonized configuration of all RUs within a given deployment. The rApps can periodically reprocess environmental data to accommodate changes in the physical layout, such as the addition or removal of partitions, relocation of furniture, or varying user density. This recursive process ensures that beamforming configurations remain current and effective, even in dynamically changing environments.

In some embodiments, the framework can initiate such adaptive sensing and optimization process through a standardized API defined by the O-RAN Alliance. For example, in some embodiments, once the rApps compute the appropriate configurations, the parameters are transmitted back to the RUs via these APIs. The RUs then implement the received parameters to adjust their beam patterns and transmit power in real time. The update interval can be configured by the network operator depending on the desired balance between responsiveness and resource consumption. For example, high-priority indoor deployments with frequently changing conditions may benefit from short update cycles, while more static environments may only require periodic recalibration.

Accordingly, as discussed herein, the disclosed framework provides innovative solutions that enable functionality for several advantages over conventional indoor propagation models and RF planning techniques. By combining environmental awareness with adaptive beamforming, the framework significantly improves the accuracy and effectiveness of indoor coverage. Additionally, the framework's functionality reduces the dependency on static, manually constructed propagation models and allows for autonomous reconfiguration in response to changes in the environment. Furthermore, the framework aligns with emerging trends in open network architectures and intelligent network management, facilitating integration with other RAN components and supporting scalable, vendor-neutral deployments.

Thus, in some embodiments, the framework can function to enable a dynamic, intelligent and context-aware approach to indoor wireless communication optimization. As discussed herein, the framework leverages advanced sensing, AI/ML, and open network principles to deliver real-time beamforming configurations tailored to complex and evolving indoor environments. Accordingly, this represents a substantial improvement over static network planning methods, offering both technical and operational benefits for next-generation wireless systems such as 5G and beyond.

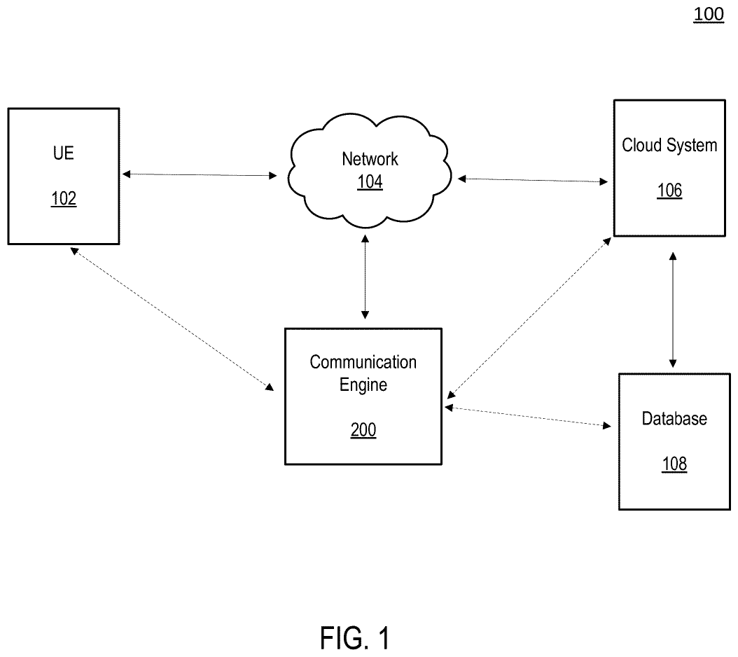

With reference to FIG. 1, system 100 is depicted which includes user equipment (UE) 102, network 104, cloud system 106, database 108, and communication engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1.

According to some embodiments, UE 102 can be any type of device operated in a mobile wireless network. For example, UE 102 can include, but not be limited to, a mobile phone, tablet, laptop, Internet of Things (IoT) device, wearable device, an autonomous guided vehicle (AGV), autonomous mobile robot (AMR), unmanned aerial vehicle (UAV), and/or any other type of device. In other non-limiting examples, UE 102 can include any type of sensor or device for adaptive indoor radio coverage, which can be integrated into the UEs above, or as separate devices/sensors, and can include, but are not limited to, RF sensors (e.g., RF sensing via ISAC), Light Detection and Ranging (LIDAR) sensors, ultrasonic sensors; infrared (IR) sensors, cameras (e.g. computer vision), millimeter wave (mmWave) radars, and the like, or some combination thereof.

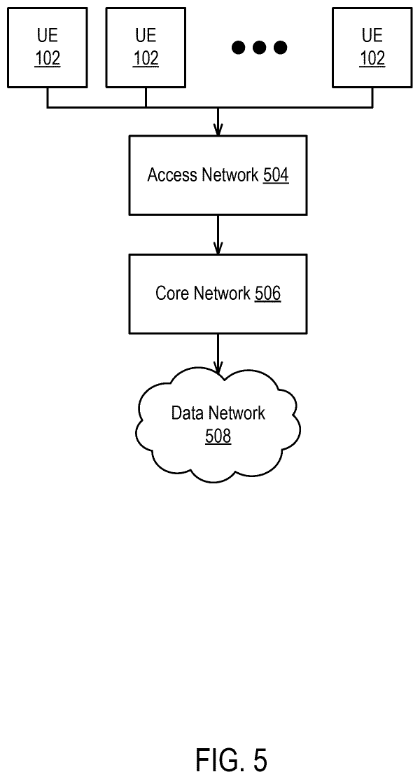

In some embodiments, network 104 can be any type of network, and can facilitate connectivity of the components of system 100, as illustrated in FIG. 1. Further discussion of embodiments of network 104 are provided below with reference to FIG. 5.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed from. For example, system 106 can represent the cloud-based infrastructure associated with a Mobile Network Operator (MNO) or the tenant of a dedicated network (e.g., network 104), and communicates with associated network resources hosted in a private or neutral host network (e.g., network 104).

In some embodiments, cloud system 106 may include a server(s) and/or a database of information. In some embodiments, a database 108 of cloud system 106 may store a set of data and/or metadata associated with network information related to the components and/or the users (e.g., UEs 102) of system 100. In addition, database 108 may store information (e.g., video content, embeddings, similarity metrics, LLMs, and the like) used by a communication engine 200, which corresponds to the novel functionality described herein.

In some embodiments, cloud system 106 can provide a private/proprietary management platform for network 104 and other devices/platforms operating thereon, and further host and/or communicate with communication engine 200.

According to some embodiments, database 108 may correspond to a data storage for a platform (e.g., a network hosted platform, such as cloud system 106) or a plurality of platforms. Database 108 may receive storage instructions/requests from, for example, communication engine 200 (and associated microservices), which may be in any type of known or to be known format, such as, for example, standard query language (SQL). Database 108 may correspond to any type of known or to be known storage, for example, a memory or memory stack of a device, a distributed ledger of a distributed network (e.g., blockchain, for example), a look-up table (LUT), and/or any other type of secure data repository.

Communication engine 200, as discussed above and further below in more detail, can include components for the disclosed functionality. According to some embodiments, communication engine 200 may be a special-purpose machine or processor within cloud system 106, or hosted by a device (or component) on network 104. In some embodiments, communication engine 200 may be hosted by a server and/or set of servers associated with cloud system 106.

According to some embodiments, communication engine 200 may be configured to implement and/or control a plurality of services and/or microservices, where each of the plurality of services/microservices are configured to execute a plurality of workflows associated with performing the disclosed estimation of backhaul bandwidth and private core capacity. Non-limiting embodiments of such workflows are provided below.

According to some embodiments, communication engine 200 may function as an application provided by and/or hosted on network 104 (e.g., any UE and/or node as discussed below in relation to FIG. 1B) and/or by cloud system 106. In some embodiments, communication engine 200 can be embodied as an application executing on UE 102 (e.g., downloaded and/or web-based execution, for example). In some embodiments, communication engine 200 may function as an application installed on a server(s), network location and/or other type of network resource associated with cloud system 106 and/or network 104. In some embodiments, communication engine 200 may be configured and/or installed as an augmenting script, program or application (e.g., a plug-in or extension) to another application or program provided by cloud system 106 and/or network 104 that is executed over network 104 and/or on UE 102.

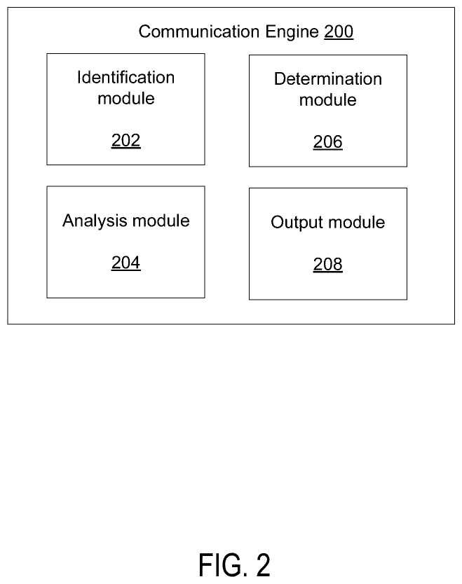

As illustrated in FIG. 2, according to some embodiments, communication engine 200 may include identification module 202, analysis module 204, determination module 206 and output module 208. It should be understood that the modules discussed herein are non-exhaustive, as additional or fewer modules (or sub-modules) may be applicable to the embodiments of the systems and methods discussed. More detail of the operations, configurations and functionalities of communication engine 200 and each of its modules, and their role within embodiments of the present disclosure will be discussed below.

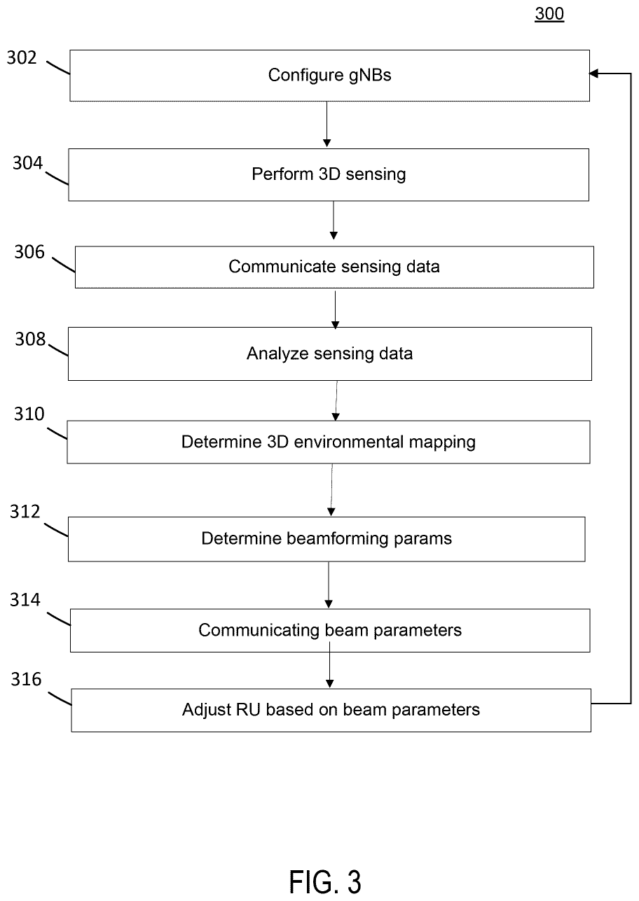

In FIG. 3, Process 300 provides non-limiting example embodiments for dynamically adjusting transmission power and beamforming parameters based on real-time environmental sensing. As discussed herein, the disclosed framework can leverage AI/ML algorithms or models to detect indoor surfaces and obstacles, thereby by providing O-RU capabilities for optimizing (e.g., curating, modifying and/or adjusting) signal propagation for improved coverage and reduced interference in indoor environments.

According to some embodiments, Steps 302 and 304 of Process 300 can be performed by identification module 202 of communication engine 200; Steps 306, 314 and 316 can be performed by output module 208; Step 308 can be performed by analysis module 204; and Steps 310 and 312 can be performed by determination module 206.

According to some embodiments, Process 300 provides steps for a systematic, intelligent control workflow for enabling and optimizing ISAC functionality within an O-RAN-compliant RAN. The process described herein includes a recursive sequence of sensing, data analysis, and configuration adjustments that leverage centralized control intelligence to enable adaptive beamforming and power optimization across distributed radio units (RUs). This process can be facilitated through the interaction between rApps (radio network automation applications), a non-real-time RAN Intelligent Controller (RIC), and distributed gNodeB (gNB) elements, including the Central Unit (CU), Distributed Unit (DU), and the Radio Unit (RU).

Accordingly, Process 300 can begin with Step 302, where an rApp initiates the configuration of the gNB architecture, including the CU, DU, and RU, to enable ISAC capabilities. This configuration step involves activating the ISAC mode at the RU level by sending control parameters and enabling signal processing capabilities required for environmental sensing. The rApp communicates with the CU/DU through standardized O-RAN management interfaces (such as an O1 interface) and with RUs via the E2 interface or other relevant APIs defined under the O-RAN Alliance specifications. These APIs enable dynamic reconfiguration of the RU operating modes and prepare the RUs to begin sensing operations, including activating beam sweeping protocols that allow for omnidirectional scanning of the surrounding indoor environment. The configuration can also include frequency planning parameters that distinguish between bands used for sensing and bands allocated for communication, which is crucial for avoiding self-interference and ensuring accurate environmental feedback.

In Step 304, once ISAC is activated, each RU begins executing a full 3D 360-degree environmental scan using its RF capabilities. The RUs employ a beam sweeping process across a range of azimuthal and elevation angles, utilizing narrowband or wideband signals depending on the desired sensing resolution. These beams, transmitted across a defined frequency band, reflect off surrounding surfaces such as walls, furniture, and structural obstructions. The RUs measure time-of-flight, signal attenuation, multipath components, and phase shift data to construct a point cloud representation of the space. The 3D scan encompasses both horizontal and vertical axes, providing a hemispherical or spherical spatial map depending on antenna configuration and room topology. Although RUs initiate the signal transmission and reception, their processing power is deliberately kept light, meaning they function primarily as data acquisition units without performing computationally intensive signal interpretation tasks.

Following the sensing phase, Step 306 involves the transmission of collected raw sensing data from each RU to the rApp through an API interface. This data, which may include radio signal returns, CSI (Channel State Information), RSSI (Received Signal Strength Indicator), delay spreads, angle-of-arrival estimates, and Doppler shifts, is sent in a structured format that can be interpreted by the central controller. Depending on the design, this API could leverage RESTful, gRPC (gRPC Remote Procedure Calls), or E2-SM-based messaging protocols defined under the O-RAN framework. Step 306 can involve offloading the data processing burden from the RU and centralize analytics and decision-making within the rApp, which has access to richer compute resources and pre-trained AI/ML models capable of pattern recognition and spatial reasoning.

In Step 308, the rApp begins analyzing the incoming sensing data to extract meaningful environmental features. According to some embodiments, Step 308's computational analysis can involve engine 200 implementing any type of known or to be known computational analysis technique, algorithm, mechanism or technology to analyze the dataset. For example, in some embodiments, engine 200 may execute and/or include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the network data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the model with a predetermined periodicity.

In some embodiments and, optionally, in combination with any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

According to some embodiments, Step 308 can involve engine 200 using advanced signal processing algorithms and AI/ML techniques, such as CNNs, clustering algorithms, and spatial segmentation models, where the rApp interprets the reflected signal characteristics to identify physical boundaries, obstacle dimensions, surface types, and the like. Engine 200 can distinguish between reflective surfaces (e.g., metal, glass) and absorptive barriers (e.g., drywall, fabric), which are critical for accurate RF propagation modeling. Engine 200 can also estimate the density and placement of objects in the area, the presence of human bodies, the probability of dynamic changes (e.g., opening doors, moved partitions), and the like, that could affect, or are capable of affecting, signal paths.

In Step 310, the rApp synthesizes the results of the data analysis into a 3D 360-degree environmental map for each RU. This map represents a geometrical and material composition layout of the indoor space from the perspective of the RU. The mapping includes both line-of-sight (LOS) and non-line-of-sight (NLOS) regions, and can include time-varying attributes such as moving obstacles or user trajectories. This spatial map can be encoded in a format suitable for computational beamforming, such as voxel grids or surface mesh models. This environmental model becomes the basis for the next step of beamforming parameter optimization and is periodically refreshed to account for temporal environmental changes.

Proceeding to Step 312, the rApp utilizes the environmental maps to determine optimal beamforming parameters for each RU. These parameters include, but are not limited to, beam angles (azimuth and elevation), beam widths, transmit power levels, modulation schemes, and the like. The rApp considers a variety of factors in its optimization process, including the spatial distribution of users (if known or estimated), service-level agreements (SLAs), interference constraints, frequency reuse patterns, and overall network performance goals. It may apply multi-objective optimization algorithms, reinforcement learning policies, or rule-based heuristics to find the configuration that maximizes signal quality and capacity while minimizing energy consumption and interference. This process ensures that each RU's beam patterns are tailored to the local environment rather than relying on static, pre-planned templates.

In Step 314, the rApp sends the optimized beamforming parameters to each RU using a standardized API. These instructions include discrete beam steering vectors, power allocations for each beam segment, and possibly scheduling hints that align with higher-layer traffic priorities. The communication protocol supports low-latency delivery and may include configuration acknowledgments, version control, and rollback mechanisms to ensure robust network behavior. These configurations can be implemented almost in real-time, allowing the network to adapt to changes such as user movement or reconfiguration of indoor layouts.

And, in Step 316, engine 200 can involve each RU applying the received beamforming parameters to adjust its antenna array configuration. This can involve, but is not limited to, recalibrating phase shifters, adjusting power amplifiers, re-aligning beamforming weights to emit beams that conform to the prescribed parameters, and the like, or some combination thereof. The RUs transition from a default or previously configured state to a new operational mode where beams are spatially and temporally optimized to current conditions. The adjustment is seamless from the user perspective, and may be accompanied by transient recalibration pulses to ensure phase and amplitude consistency.

According to some embodiments, the sequence of processing steps in Process 300 can be recursive and adaptive, in that the process can be periodically repeated and/or triggered in response to specific events or thresholds (e.g., detection of significant environmental change, periodic timer expirations, or degradation in network performance metrics). In some embodiments, the period of repetition is configurable by the network operator, allowing trade-offs between responsiveness and computational overhead. Additionally, feedback loops may be established whereby RUs report back the results of the beam adjustments (e.g., post-configuration signal quality) to help refine and recalculate future iterations (e.g., reperform steps to update adjustments/configurations for RUs based on updated mappings, as discussed supra). Such recursive loop embodies a closed-loop control architecture characteristic of intelligent RAN systems, where sensing, analysis, and actuation are continuously aligned.

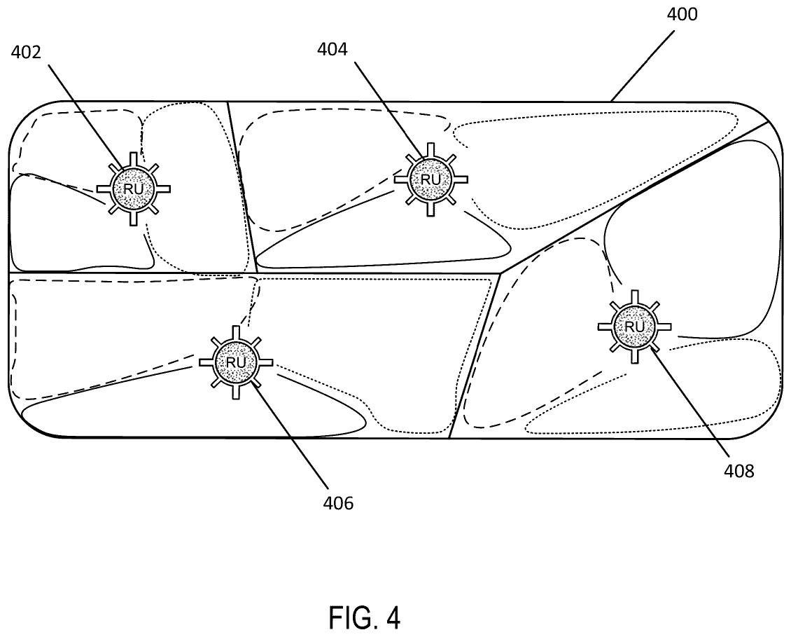

Turning to FIG. 4, depicted is an example diagram that includes several RUS deployed within an indoor space (or environment) 400, each with multiple beams directed in various orientations, as discussed herein. Each RU (402, 404, 406 and 408) is within a room, as provided via detected surfaces (e.g., walls). The solid lines, dotted lines and dashed lines illustrate different beam patterns, which can be distinguished by frequency, direction, and/or power level, as discussed supra. These beams are shaped and controlled based on the environmental data, which can minimize interference between neighboring beams and sectors. In some embodiments, the beams may be swept in grids or specific patterns, and their shapes may diverge from traditional uniform lobes, reflecting their adaptation to complex spatial configurations.

Accordingly, FIG. 4 represents a high-level conceptual visualization of adaptive indoor beamforming coverage achieved through the execution of Process 300 by engine 200. FIG. 4 shows an indoor space 400 divided into distinct zones or sectors, each containing an RU (402, 404, 406, 408), which dynamically senses and adjusts to the environment using the centralized intelligence of a non-real-time RIC operating rApps.

As mentioned above, the solid lines for each RU (402, 404, 406, 408) represent the physical surfaces or boundaries detected by the RUs (402, 404, 406, 408) during the 3D 360-degree sensing phase (Step 304). These are actual physical barriers such as walls, partitions, or large objects that affect RF propagation. The RUs (402, 404, 406, 408) use signal reflections and scattering characteristics to infer the presence of these boundaries. These surfaces are integral to the construction of the 3D environment maps in Step 310 and are used by the rApp to shape and constrain beam paths for optimized performance.

The dotted lines correspond to beamforming paths or communication beams that have been determined and deployed by each RU (402, 404, 406, 408) based on sensing feedback and centralized optimization (Steps 312-316). The dotted pattern can indicate dynamic or lower-power beams that could vary in power level, modulation, or direction over time. These beams are the outcome of real-time adjustments made by the RU (402, 404, 406, 408) as instructed by the rApp via APIs, aligning with the adaptive behavior described in Step 316.

The dashed lines indicate sensed signal returns or sensing vectors used during the initial 360-degree scan phase (Step 304). They visualize how the RUs (402, 404, 406, 408) transmit probing signals in all directions to gather environmental data. These sensing rays, although not used directly for communication, are critical inputs for constructing the environmental map (Step 310) and inform the beamforming decisions.

Accordingly, as discussed above, with reference to the steps of Process 300, each RU (402, 404, 406, 408), represented visually in the center of a local coverage zone, acts as both a communication transmitter/receiver and a sensing node. During the ISAC process:
i. The dashed lines show the RU's (402, 404, 406, 408) active sensing phase, where sweeping beams are emitted to detect the physical layout of the room.
ii. Reflections from surfaces (solid lines) are received back and sent to the rApp (Step 306).
iii. After the rApp processes this data (Steps 308-312), it generates and transmits optimized beamforming parameters.
iv. These adjustments result in the dotted lines: beams that are fine-tuned for optimal signal propagation and minimal interference.

Accordingly, as discussed herein, the disclosed systems and methods provide a framework for a dynamic, intelligent and context-aware approach to indoor wireless communication optimization by leveraging advanced sensing and open network principles to provide functionality for real-time beamforming configurations tailored to complex and evolving indoor environments.

FIG. 5 is a block diagram of an example network architecture according to some embodiments of the present disclosure. In the illustrated embodiment, UE 102 accesses a data network 508 via an access network 504 and a core network 506.

In the illustrated embodiment, the access network 504 comprises a network allowing network communication with UE 102. In general, the access network 504 includes at least one base station that is communicatively coupled to the core network 506 and coupled to zero or more UE 102.

In some embodiments, the access network 504 comprises a cellular access network, for example, a 5G network. In an embodiment, the access network 504 can include a NextGen Radio Access Network (NG-RAN). In an embodiment, the access network 504 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 506 and to external network-attached elements in a data network 508 such as the Internet.

In the illustrated embodiment, the access network 504 and the core network 506 are operated by a NO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 102 can connect to this network similar to connecting to a national or regional network.

In some embodiments, the access network 504, core network 506 and data network 508 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

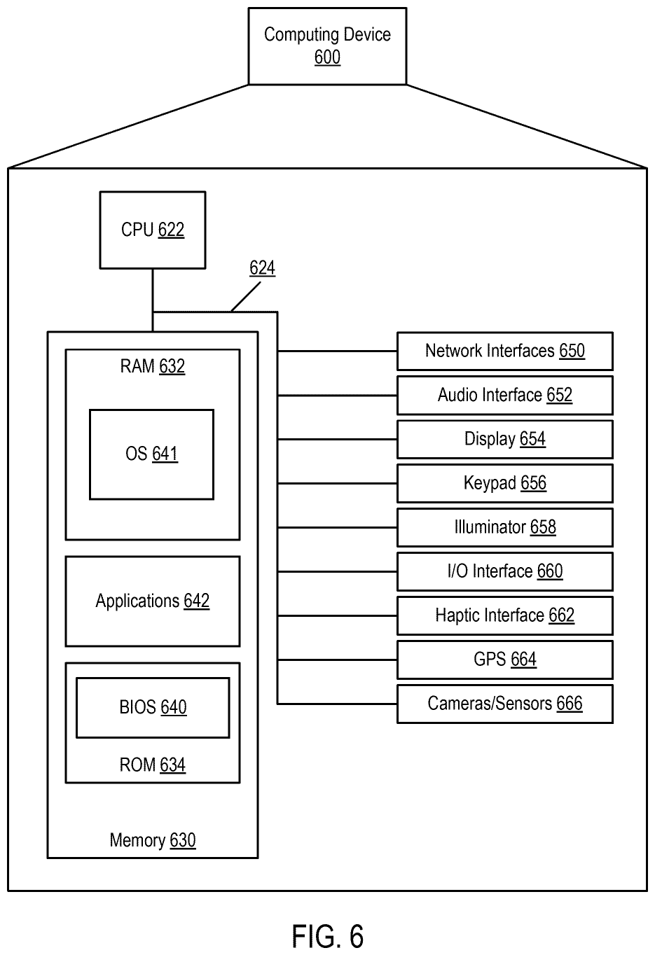

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a CPU 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to ROM 634.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special-purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
activating, for a radio unit (RU) within an environment, an integrated sensing and communications (ISAC) mode;
executing an environmental scan using radio frequency (RF) capabilities of the RU, the environmental scan comprising collecting sensing data for the environment respective to the RU;
analyzing, by a radio access network application (rApp), the sensing data to extract environmental features;
synthesizing the environmental features into an environmental map for the RU;
determining, based on the environmental map, beamforming parameters for the RU; and
causing configuration of an antenna array configuration for the RU based on the determined beamforming parameters.

2. The method of claim 1, further comprising initiating, by the rApp, configuration of a gNodeB (gNB) architecture associated with the environment, the activation of the ISAC mode enabled via the initiated configuration.

3. The method of claim 1, further comprising:
performing a beam sweeping process across a range of azimuthal and elevation angles;
utilizing narrowband or wideband signals based on a desired sensing resolution; and
measuring at least one of time-of-flight, signal attenuation, multipath components or phase shift data to construct a point cloud representation of a space, wherein the determined environmental map is based on the measuring.

4. The method of claim 1, wherein the environmental map comprises a three-dimensional (3D), 360-degree mapping around the RU.

5. The method of claim 1, further comprising:
distinguishing between reflective surfaces and absorptive barriers;
estimating density and placement of objects in the environment; and
identifying a probability of dynamic changes that are capable of affecting signal paths, wherein the analysis of the sensing data is based on the identifying.

6. The method of claim 1, wherein the beamforming parameters are selected from a group consisting of at least one of: spatial distribution of users; service-level agreements (SLAs);
interference constraints; frequency reuse patterns; and network performance goals.

7. The method of claim 1, wherein the determining of beamforming parameters is based on determining configurations that maximize signal quality and capacity while minimizing energy consumption and interference.

8. The method of claim 1, further comprising:
detecting changes in the environment;
updating the environmental map based on the detected changes;
recalculating the beamforming parameters based on the updated environmental map; and
updating the configuration of the RU based on the recalculating.

9. A system comprising:
one or more processors configured to:
activate, for a radio unit (RU) within an environment, an integrated sensing and communications (ISAC) mode;
execute an environmental scan using radio frequency (RF) capabilities of the RU, the environmental scan comprising collecting sensing data for the environment respective to the RU;
analyze, by a radio access network application (rApp), the sensing data to extract environmental features;
synthesize the environmental features into an environmental map for the RU;
determine, based on the environmental map, beamforming parameters for the RU; and
cause configuration of an antenna array configuration for the RU based on the determined beamforming parameters.

10. The system of claim 9, wherein the one or more processors are further configured to initiate, by the rApp, configuration of a gNodeB (gNB) architecture associated with the environment, the activation of the ISAC mode enabled via the initiated configuration.

11. The system of claim 9, wherein the one or more processors are further configured to:
perform a beam sweeping process across a range of azimuthal and elevation angles;
utilize narrowband or wideband signals based on a desired sensing resolution; and
measure at least one of time-of-flight, signal attenuation, multipath components or phase shift data to construct a point cloud representation of a space, wherein the determined environmental map is based on the measuring.

12. The system of claim 9, wherein the one or more processors are further configured such that the environmental map comprises a three-dimensional (3D), 360-degree mapping around the RU.

13. The system of claim 9, wherein the one or more processors are further configured to:
distinguish between reflective surfaces and absorptive barriers;
estimate density and placement of objects in the environment; and
identify a probability of dynamic changes that are capable of affecting signal paths, wherein the analysis of the sensing data is based on the identifying.

14. The system of claim 9, wherein the one or more processors are further configured such that the beamforming parameters are selected from a group consisting of: spatial distribution of users; service-level agreements (SLAs); interference constraints; frequency reuse patterns; and network performance goals.

15. The system of claim 9, wherein the one or more processors are further configured such that the determination of beamforming parameters are based on determined configurations that maximize signal quality and capacity while minimizing energy consumption and interference.

16. The system of claim 9, wherein the one or more processors are further configured to:
detect changes in the environment;
update the environmental map based on the detected changes;
recalculate the beamforming parameters based on the updated environmental map; and
update the configuration of the RU based on the recalculating.

17. A non-transitory computer-readable storage medium tangibly encoded with computer-executable instructions, that when executed by a device, perform a method comprising:
activating, for a radio unit (RU) within an environment, an integrated sensing and communications (ISAC) mode;
executing an environmental scan using radio frequency (RF) capabilities of the RU, the environmental scan comprising collecting sensing data for the environment respective to the RU;
analyzing, by a radio access network application (rApp), the sensing data to extract environmental features;
synthesizing the environmental features into an environmental map for the RU;
determining, based on the environmental map, beamforming parameters for the RU; and
causing configuration of an antenna array configuration for the RU based on the determined beamforming parameters.

18. The non-transitory computer-readable storage medium of claim 17, further comprising:
performing a beam sweeping process across a range of azimuthal and elevation angles;
utilizing narrowband or wideband signals based on a desired sensing resolution; and
measuring at least one of time-of-flight, signal attenuation, multipath components or phase shift data to construct a point cloud representation of a space, wherein the determined environmental map is based on the measuring.

19. The non-transitory computer-readable storage medium of claim 17, further comprising:
distinguishing between reflective surfaces and absorptive barriers;
estimating density and placement of objects in the environment; and
identifying a probability of dynamic changes that are capable of affecting signal paths, wherein the analysis of the sensing data is based on the identifying.

20. The non-transitory computer-readable storage medium of claim 17, further comprising:
detecting changes in the environment;
updating the environmental map based on the detected changes;
recalculating the beamforming parameters based on the updated environmental map; and
updating the configuration of the RU based on the recalculating.
